(19) United States
(12) Patent Application Publication
(10) Pub. No.: US 2003/0128727 A1
(43) Pub. Date: Jul. 10, 2003

(54) Semiconductor laser module

(76) Inventor: Hiroyasu Torazawa, Tokyo (JP)

Correspondence Address: VOLENTINE FRANCOS, PLLC, Suite 150, 12200 Sunrise Vally Drive, Reston, VA, 20191, US

(21) Appl. No.: 10/252,790

(22) Filed: Sep. 24, 2002

(30) Foreign Application Priority Data
Jan. 9, 2002 (JP) 002220/2002

(51) Int. Cl. H01S 3/13; H01S 3/04

(52) U.S. Cl. 372/36; 372/32

(57) ABSTRACT

Light emitted backward from a semiconductor laser device 1 is brought to parallel light by a lens 2, which in turn is incident to a filter 4 having a wavelength selectivity, where it is divided into transmitted light and reflected light. The transmitted light is launched into a light-receiving element 5, whereas the reflected light falls on a light-receiving element 6. Each of the light-receiving elements 5 and 6 has a photoelectric transfer function and outputs a photocurrent corresponding to the accepted amount of light. When the wavelength of the light emitted from the semiconductor laser device 1 varies, the amount of the light transmitted through the filter 4 varies and hence the amount of a photocurrent outputted from the light-receiving element 5 varies. When an optical output of the semiconductor laser device 1 varies, the amount of a photocurrent outputted from the light-receiving element 6 varies. A variation in the wavelength and a variation in optical output can respectively be detected by the light-receiving element 5 and the light-receiving element 6.

### BACKGROUND OF THE INVENTION

The present invention relates to a semiconductor laser module having the function of controlling the wavelength of outgoing laser light.

A semiconductor laser module comprises a semiconductor laser device, a light-receiving element, and an element for temperature control, etc. that have been mounted within a package. The semiconductor laser device is of a main device of the semiconductor laser module and emits laser light having a predetermined wavelength with the application of a current. The wavelength of the laser light varies with self-heating, a variation in ambient temperature, etc. Further, the output of the laser light varies with a variation in drive source, a temperature variation due to self-heating or the like, etc. Thus, the wavelength of the laser light emitted from the semiconductor laser device and its optical output highly depend on the temperature. To this end, in general, part of laser light is launched into a light-receiving element, and the temperature is controlled using a temperature control element while the output of the light-receiving element is being monitored, whereby the wavelength of the laser light and its optical output are controlled.

FIG. 1 is a cut-out perspective view of a semiconductor laser module as a first conventional example, and FIG. 2 is a configurational view thereof, respectively. The semiconductor laser module is configured as follows: A semiconductor laser device 1, a light-receiving element 6, a thermistor element 7 and a lens 8 are mounted on a sub-board 9. The sub-board 9 is mounted on a peltier element 10. They are mounted inside a package 11 made up of a metal. An isolator 12 and an optical fiber 13 are coupled to the package 11.

The semiconductor laser device 1 emits laser light having a predetermined wavelength forward and backward. The backward-emitted light is launched into the light-receiving element 6. The light-receiving element 6 has a photoelectric transfer function and outputs a photocurrent having an optical current amount corresponding to the accepted amount of light. The forward-emitted light is converged by the lens 8 and launched into the optical fiber via the isolator 12 with a lens, followed by output to the outside. The isolator 12 is used to eliminate the influence of reflection of the laser light. The temperature is controlled by the thermistor element 7 and the peltier element 10.

Variations in the optical output of the laser light emitted from the semiconductor laser device 1 appear on the forward-emitted light and the backward-emitted light similarly. When the optical output of the laser light varies, the amount of the light received by the light-receiving element 6 varies and hence the amount of a photocurrent outputted from the light-receiving element 6 varies. The temperature is controlled by the thermistor element 7 and the peltier element 10 while monitoring the variation in the amount of the photocurrent of the light-receiving element, whereby the optical output of the semiconductor laser device 1 is controlled so as to take a constant value.

FIG. 3 is a cut-out perspective view of a semiconductor laser module used as a second conventional example, and FIG. 4 is a configurational view thereof, respectively. The module according to the present example includes a lens 2, a beam splitter 3, a filter 4 and a light-receiving element 5 in addition to the respective parts employed in the first conventional example. They are mounted on a sub-board 9. The filter 4 has a wavelength selectivity and varies in transmittance depending on the wavelength of incident light. An etalon element or the like is used for the filter 4. The light-receiving element 5 has a photoelectric transfer function and outputs a photocurrent having an optical current amount corresponding to the accepted amount of light.

Light emitted backward from the semiconductor laser device 1 is brought to parallel light by the lens 2 and thereafter divided into two directions by the beam splitter 3: one direction of an optical axis 20 and another direction orthogonal to the optical axis 20. Now the direction in which the light is emitted forward and backward from the semiconductor laser device 1, is assumed as the direction of the optical axis 20. The light, which is emitted from the beam splitter 3 and moved in the direction of the optical axis 20, passes through the filter 4, followed by incident to the light-receiving element 5. The light, which has traveled in the direction orthogonal to the optical axis 20, is launched into the light-receiving element 6.

When the oscillated wavelength of the laser light emitted from the semiconductor laser device 1 varies, the amount of the light transmitted through the filter 4 varies, and the amount of the light received by the light-receiving element 5 varies. This appears as a variation in the amount of a photocurrent outputted by the light-receiving element 5. When the optical output of the laser light emitted from the semiconductor laser device 1 varies, the amount of the light received by the light-receiving element 6 varies, and hence it appears as a variation in the amount of a photocurrent outputted by the light-receiving element 6. Namely, the light-receiving element 5 serves as an oscillated wavelength control monitor, whereas the light-receiving element 6 serves as an optical output control monitor. The temperature is controlled by the thermistor element 7 and the peltier element 10 while monitoring the variations in the amounts of the photocurrents of the light-receiving elements 5 and 6, whereby the oscillated wavelength and optical output of the semiconductor laser device 1 are respectively controlled so as to take a constant value. The module according to the present example controls not only the optical output of the outputted laser light but also its wavelength and has a wavelength lock function.

However, the semiconductor laser module having the wavelength lock function referred to above needs to have the beam splitter 3 in order to divide the backward-radiated light of the semiconductor laser device 1, and to make up optical systems in two directions different 90° from each other in angle. Therefore, a problem arises in that the number of mounted components increases and a space necessary for packaging becomes large.

### SUMMARY OF THE INVENTION

The present invention may provide a semiconductor laser module capable of reducing the number of mounted components and being configured in compact form.

Light emitted backward from a semiconductor laser device is brought to parallel light by a lens, which in turn is incident to a filter having a wavelength selectivity, where it is divided into transmitted light and reflected light. The transmitted light is launched into a light-receiving element, whereas the reflected light falls on a light-receiving element. Each of the light-receiving elements has a photoelectric transfer function and outputs a photocurrent corresponding to the accepted amount of light. When the wavelength of the light emitted from the semiconductor laser device varies, the amount of the light transmitted through the filter varies and hence the amount of a photocurrent outputted from the light-receiving element varies. When an optical output of the semiconductor laser device varies, the amount of a photocurrent outputted from the light-receiving element varies. A variation in the wavelength and a variation in optical output can respectively be detected by the light-receiving element and the light-receiving element.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a cut-out perspective view showing a first conventional semiconductor laser module;

FIG. 2 is a configurational view illustrating the first conventional semiconductor laser module;

FIG. 3 is a cut-out perspective view showing a second conventional semiconductor laser module;

FIG. 4 is a configurational view illustrating the second conventional semiconductor laser module;

FIG. 5 is a configurational view showing a semiconductor laser module according to a first embodiment of the present invention;

FIG. 6 is a configurational view depicting a semiconductor laser module according to a second embodiment of the present invention;

FIG. 7 is a configurational view illustrating a semiconductor laser module according to a third embodiment of the present invention; and

FIG. 8 is a configurational view showing a semiconductor laser module according to a fourth embodiment of the present invention.

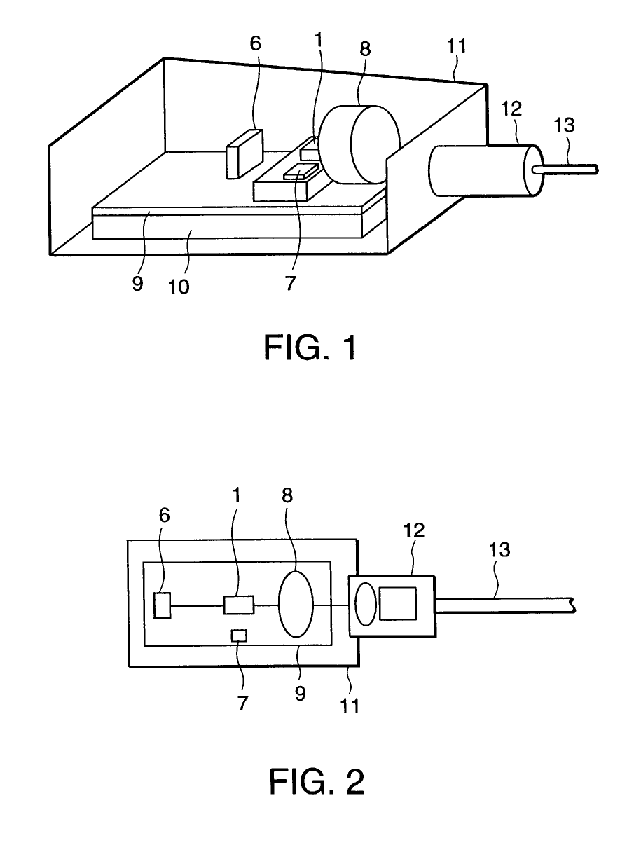

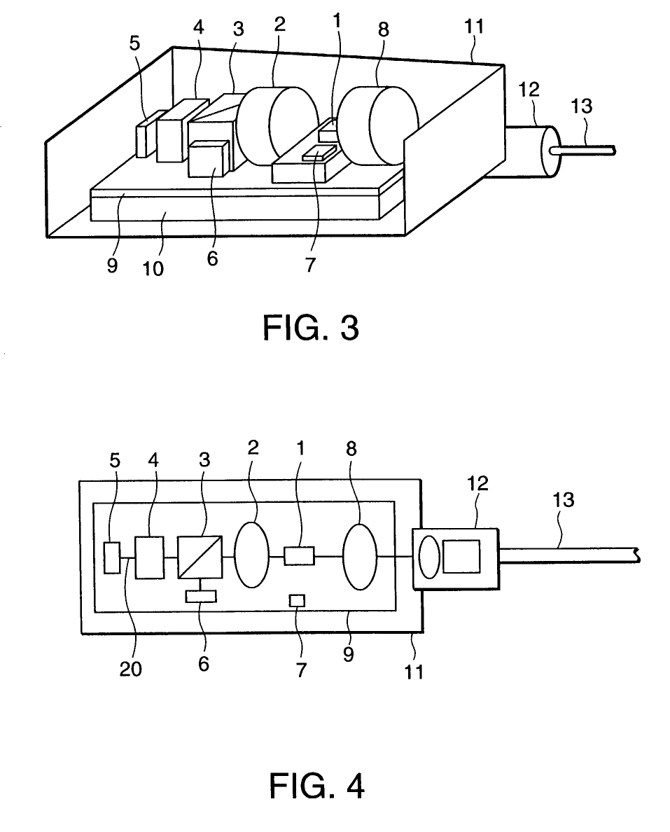

### DETAILED DESCRIPTION OF THE PREFERRED EMBODIMENTS

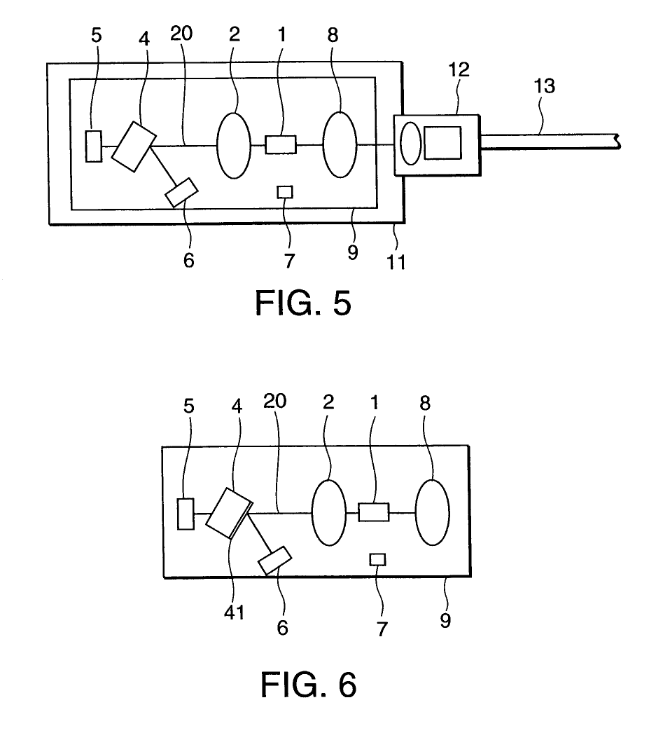

Preferred embodiments of the present invention will hereinafter be described in detail with reference to the accompanying drawings. Incidentally, elements of structure each having substantially the same function and configuration are respectively identified by the same reference numerals in the following description and the accompanying drawings, and the description of common elements of structure will therefore be omitted. FIG. 5 is a configurational view showing a semiconductor laser module according to a first embodiment of the present invention.

The semiconductor laser module has a semiconductor laser device 1, a lens 2, a filter 4, a light-receiving element 5, a light-receiving element 6, a thermistor element 7, and a lens 8. These are mounted on a sub-board 9. The sub-board 9 is placed on a peltier element (not shown). The parts referred to above are mounted inside a package 11 made up of a metal. An isolator 12 and an optical fiber 13 are coupled to the package 11. The semiconductor laser device 1, light-receiving element 5, light-receiving element 6, thermistor element 7 and peltier element are respectively connected to their corresponding terminals of the package 11 with gold wires or the like.

The semiconductor laser device 1 is of a main device of the present module. The semiconductor laser device 1 radiate laser light having a predetermined wavelength forward and backward with a spread angle according to the application of a current. The forward-radiated light is handled as light outputted from the present module. The backward-radiated light is used for monitoring an oscillated wavelength and an optical output.

The lens 2 is used to bring light emitted from the semiconductor laser device 1 to parallel light. The filter 4 has a wavelength selectivity and varies in transmittance depending on the wavelength of the incident light. For example, an etalon element is used for the filter 4. In general, the etalon element has a pair of parallel planes surface-ground with high accuracy. Owing to the utilization of the interference of light at the planes, the etalon element has a wavelength selectivity. Described specifically, for example, the etalon element is formed by evaporating a dielectric multilayer film onto the surface-grounded surface and back of parallel plate quartz glass with the quartz glass as a material.

The light-receiving element 5 and the light-receiving element 6 respectively have photoelectric transfer functions and output photocurrents each having the amount of the photocurrent corresponding to the accepted amount of light. The thermistor element 7 and the peltier element are used for temperature control. Since the components or constituent parts such as the semiconductor laser device 1, etc. are mounted on the peltier element with the sub-board 9 interposed therebetween, these components are equally placed under temperature control by the peltier element. The lens 8 has the function of converging light emitted from the semiconductor laser device 1 and allowing the converged light to enter the optical fiber 13 efficiently. The isolator 12 is used to eliminate the influence of reflection of the laser light. The isolator 12 is equipped with a lens in the present embodiment.

As shown in FIG. 5, the lens 8, the isolator 12 and the optical fiber 13 are disposed in turn on an optical path ahead of the semiconductor laser device 1. An optical path at the rear of the semiconductor laser device 1 is divided by the filter 4, so that an optical path extending in the direction of an optical axis 20 and an optical path having an angle to the optical axis 20 are formed. Now the direction in which the light is radiated forward and backward from the semiconductor laser device 1, is defined as the direction of the optical axis 20. The lens 2, the filter 4 and the light-receiving element 5 are disposed in order on the optical path extending in the direction of the optical axis 20. The optical path having the angle to the optical axis 20 lies in the direction in which the light emitted from the semiconductor laser device 1 and reflected by an incident surface of the filter 4 travels. The light-receiving element 6 is placed on the optical axis.

The light, which is radiated backward from the semiconductor laser device 1 with a spread angle, is converted into parallel light by the lens 2, which is thereafter launched into the filter 4, where it is divided into transmitted light and reflected light. The light transmitted through the filter 4 is launched into the light-receiving element 5. The light-receiving element 5 produces a photocurrent corresponding to the received amount of light. When the wavelength of the laser light emitted from the semiconductor laser device 1 varies, the amount of the light transmitted through the filter 4 varies based on wavelength dependency of the filter 4, and the amount of the light received by the light-receiving element 5 varies. Hence the amount of a photocurrent outputted from the light-receiving element 5 varies. Thus, a variation in wavelength can be detected by monitoring the amount of the photocurrent of the light-receiving element 5.

The light reflected by the incident surface of the filter 4 is launched into the light-receiving element 6. The light-receiving element 6 produces a photocurrent corresponding to the received amount of light. When the optical output of the laser light emitted from the semiconductor laser device 1 varies, the amount of the light received by the light-receiving element 6 varies, and hence the amount of a photocurrent outputted from the light-receiving element 6 varies. Thus, the monitoring of the amount of the photocurrent of the light-receiving element 6 enables detection of a variation in optical output.

As described above, the laser light emitted from the semiconductor laser device 1 varies in wavelength and optical output due to a temperature variation. The temperature is controlled under the thermistor element 7 and the peltier element while monitoring the amounts of the photocurrents from the light-receiving element 5 and the light-receiving element 6, thereby making it possible to control the wavelength of the light emitted from the semiconductor laser device 1 and its optical output. As described above, the present module controls not only the optical output but also the wavelength and has a wavelength lock function.

The light forward emitted from the semiconductor laser device 1 is converted by the lens 8 and launched into the optical fiber 13 via the isolator 12, from which the converged light is outputted.

According to the present embodiment as described above, the light reflected from the incident surface of the filter 4 is launched into the light-receiving element 6 to detect the variation in optical output. Utilizing the light reflected by the filter as well as the light transmitted through the filter 4 in this way brings about the formation of the two optical paths for the light-receiving element 5 and the light-receiving element 6. Thus, the present module needs not to use an optical path dividing element such as the beam splitter or the like, which has heretofore been needed. It is thus possible to reduce the number of components, reduce a mounting area and construct the module in compact form as compared with the related art. Since thermal capacity is reduced with the decrease in the number of the components, the rate of reaction with a temperature variation is increased. Further, since the number of the parts mounted on the peltier element with the sub-board 9 interposed therebetween decreases, the capability of controlling the temperature by the peltier element is enhanced.

FIG. 6 is a fragmentary configurational view showing a semiconductor laser module according to a second embodiment of the present invention. In the present embodiment, a reflection film 41 is formed on an incident surface of a filter 4, corresponding to a surface facing a light-receiving element 6, as means for enhancing reflectance. Since other elements of structure are similar to those employed in the first embodiment, the description of certain common elements will be omitted. Only principal constituent parts on a sub-board 9 are illustrated in FIG. 6, and a package 11, an isolator 12 and an optical fiber 13 are not shown in the drawing.

In general, the reflectance at the incident surface of the filter 4 having a wavelength selectivity is determined depending on the characteristic of the filter. Therefore, a desired intensity of reflected light might not be obtained due to the influence of a dielectric film formed on the surface of the filter 4. In the present embodiment, the reflection film 41 is formed on the incident surface of the filter 4. Consequently, the desired intensity of reflected light can be obtained without limitations on the reflectance determined according to the characteristic of the filter 4.

The reflectance of the reflection film 41 is determined in such a manner that the desired amounts of reflected light and transmitted light are obtained at the filter 4. A material for the reflection film 41 is determined in consideration of the wavelength of the light emitted from the semiconductor laser device 1. The size of the reflection film 41 is determined in consideration of the size of a cross-section of a luminous flux incident to the filter 4. The reflection film 41 can be formed by, for example, evaporating a metal film, a dielectric multilayer film or the like or carrying out chemical adhesion thereof. It is also considered that a member formed with the reflection film 41 as the means for achieving an improvement in reflectance is mechanically bonded on the sub-board 9 with an adhesive or the like.

Incidentally, a method for removing part of the dielectric film to expose a filter substrate as well as for adding the reflection film is also considered as a method for taking measures against the case where the desired intensity of reflected light is not obtained due to the influence of the dielectric film having the wavelength selectivity, which is formed on the surface of the filter 4.

According to the present embodiment, an effect similar to the first embodiment is obtained. Further, the intensity of the reflected light can be enhanced by the reflection film 41 without restrictions on the characteristic of the filter 4. Furthermore, the optimum setting of the area of the filter 4 makes it possible to adjust the amount of the reflected light and allows the arbitrary setting of a balance between the amount of the reflected light and the amount of the transmitted light at the filter 4.

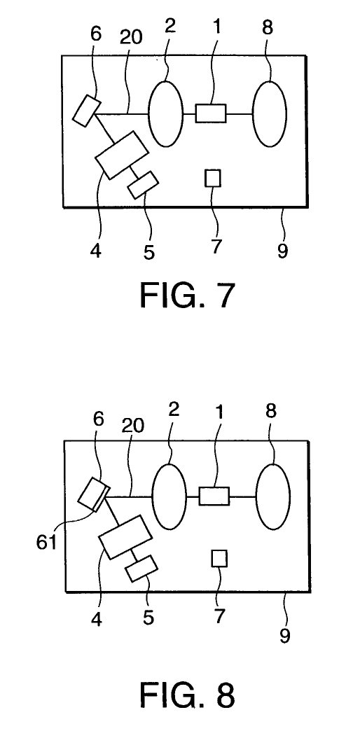

FIG. 7 is a fragmentary configurational view showing a semiconductor laser module according to a third embodiment of the present invention. In the present embodiment, the layout of a filter 4, a light-receiving element 5 and a light-receiving element 6 is different from that in the first embodiment. Since other elements of structure are similar to those employed in the first embodiment, the description of certain common elements will be omitted. Only principal constituent parts on a sub-board 9 are illustrated in FIG. 7, and a package 11, an isolator 12 and an optical fiber 13 are not shown in the drawing.

In the present embodiment, a lens 2 and a light-receiving element 6 are disposed in order in the direction of an optical axis 20 as viewed on an optical path at the rear of a semiconductor laser device 1. An optical path extending therebehind is folded back. The light-receiving element 6 is disposed with its incident surface being inclined to the optical axis 20. An optical path is formed which is bent in the direction in which light emitted from the semiconductor laser device 1 and reflected by the incident surface of the light-receiving element 6 travels. The filter 4 and the light-receiving element 5 are disposed on the optical path in order.

The light emitted backward from the semiconductor laser device 1 with a spread angle is converted into parallel light by the lens 2, which is thereafter launched into the light-receiving element 6. Part of the launched light is received by the light-receiving element 6 and the remaining part thereof results in reflected light. After the light has passed through the filter 4, it is launched into the light-receiving element 5. The light-receiving element 6 generates a photocurrent corresponding to the received amount of light. When an optical output of the laser light emitted from the semiconductor laser device 1 varies, the amount of the light received by the light-receiving element 6 varies and hence the amount of a photocurrent outputted from the light-receiving element 6 varies. Thus, the monitoring of the amount of the photocurrent of the light-receiving element 6 enables detection of a variation in optical output.

The light-receiving element 5 generates a photocurrent corresponding to the received amount of light. When the wavelength of the laser light emitted from the semiconductor laser device 1 varies, the amount of the light transmitted through the filter 4 varies based on wavelength dependency of the filter 4, and the amount of the light received by the light-receiving element 5 varies. Hence the amount of a photocurrent outputted by the light-receiving element 5 varies. Thus, a wavelength variation can be detected by monitoring the amount of the photocurrent of the light-receiving element 5.

In the first embodiment, the filter 4 is used as the optical path dividing means and disposed such that the light reflected by the incident surface of the filter 4 is launched into the light-receiving element 6. On the other hand, in the present embodiment, the light-receiving element 6 is disposed such that the optical path is bent by the light-receiving element 6 and the light reflected by the incident surface of the light-receiving element 6 is launched into the filter 4 and the light-receiving element 5. In a manner similar to the first embodiment even in the case of the present embodiment, the temperature is controlled by a thermistor element 7 and a peltier element while monitoring the. amounts of the photocurrents from the light-receiving element 5 and the light-receiving element 6, whereby the wavelength of the light emitted from the semiconductor laser device 1 and its optical output can be controlled.

According to the present embodiment, the light reflected by the incident surface of the light-receiving element 6 is launched into the light-receiving element 5 via the filter 4 to detect a variation in wavelength. Owing to the utilization of the light reflected by the light-receiving element 6 in this way, the light emitted from the semiconductor laser device 1 can be introduced into the two light-receiving elements 5 and 6. Thus, the present module needs not to use the optical path dividing element such as the beam splitter or the like which has heretofore been required. It is therefore possible to reduce the number of components, cut down a mounting area and configure the module in compact form as compared with the related art. Since thermal capacity decreases with a reduction in the number of the components, the rate of reaction with a temperature variation is increased. Further, since the number of the parts mounted on the peltier element with the sub-board 9 interposed therebetween decreases, the capability of controlling the temperature by the peltier element is enhanced. As described above, the reflectance at the incident surface of the filter 4 having a wavelength selectivity is normally determined based on the characteristic of the filter. Therefore, the aforementioned embodiment needs to form the reflection film on the filter 4 where no desired intensity of reflected light is obtained. In the present embodiment, however, there is no need to form it.

FIG. 8 is a fragmentary configurational view showing a semiconductor laser module according to a fourth embodiment of the present invention. In the present embodiment, a reflection film 61 is formed on an incident surface of a light-receiving element 6 as means for achieving an improvement in the reflectance. Since other elements of structure are similar to those employed in the third embodiment, the description of common elements will be omitted. Only principal constituent parts on a sub-board 9 are illustrated in FIG. 8, and a package 11, an isolator 12 and an optical fiber 13 are not shown in the drawing.

Specifications for the reflection film 61, such as a material, sizes, etc. are determined in consideration of desired amounts of reflected and transmitted lights, the wavelength of radiated light, a sectional size of an incident luminous flux, etc. in a manner similar to the reflection film 41. The reflection film 61 can be formed by, for example, evaporating a metal film, a dielectric multilayer film or the like or carrying out chemical adhesion thereof. It is also considered that a member formed with the reflection film 61 as the means for achieving an improvement in reflectance is mechanically bonded on the sub-board 9 with an adhesive or the like.

According to the present embodiment, an effect similar to the third embodiment is obtained. Further, the intensity of the reflected light can be enhanced by the reflection film 61. Furthermore, the optimum setting of the area of the reflection film 61 makes it possible to adjust the amount of the reflected light and allows the arbitrary setting of a balance between the amount of the reflected light and the amount of the transmitted light at the light-receiving element 5.

While the preferred embodiments according to the present invention have been described above with reference to the accompanying drawings, it is needless to say that the invention is not limited to the embodiments. It will be apparent to those skilled in the art that various changes or modifications can be supposed to be made to the invention within the scope of a technical idea described in the following claims. It is understood that those modifications and changes fall within the technical scope of the invention.

What is claimed is:

1. A semiconductor laser module, comprising:
a semiconductor laser device;
a filter having a wavelength selectivity, for launching therein laser light emitted from said semiconductor laser device, allowing part of the incident light to pass therethrough and reflecting the other part of the incident light;
a first light-receiving element for receiving the light reflected by said filter; and
a second light-receiving element for receiving the light transmitted through said filter;
wherein a variation in optical output of the laser light and a variation in the wavelength thereof are detected based on an output from said first light-receiving element and an output from said second light-receiving element.

2. The semiconductor laser module according to claim 1, wherein a reflection film is provided on a surface of said filter, which faces said first light-receiving element.

3. A semiconductor laser module, comprising:
a semiconductor laser device;
a first light-receiving element for launching therein laser light emitted from said semiconductor laser device, receiving therein part of the laser light and reflecting the other part of the incident light;
a filter in which the light reflected by said first light-receiving element is launched and having a wavelength selectivity; and
a second light-receiving element for receiving the light transmitted through said filter;
wherein a variation in optical output of the laser light and a variation in the wavelength thereof are detected based on an output from said first light-receiving element and an output from said second light-receiving element.

4. The semiconductor laser module according to claim 3, wherein a reflection film is provided on a surface of said first light-receiving element, which faces said filter.
